(19) United States
(12) Patent Application Publication
(10) Pub. No.: US 2007/0070363 A1
(43) Pub. Date: Mar. 29, 2007

(54) Color processing color data undefined to a gamut

(76) Inventor: Huanzhao Zeng, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/234,525

(22) Filed: Sep. 23, 2005

(51) Int. Cl. H04N 1/60

(52) U.S. Cl. 358/1.9

(57) ABSTRACT

Methods, computer readable media, computing devices, and ASICs that include executable program instructions are provided for processing color data undefined to a first gamut. One method embodiment includes receiving color data to a source device, e.g., first device, having a defined color gamut, and preserving color data that are undefined for the source device color gamut. This embodiment also includes mapping color data that are inside the first device color gamut to a second device, having a defined color gamut, and mapping color data that are outside the first device color gamut to the second device color gamut.

### INTRODUCTION

A color device is not able to produce all colors. A color gamut is a range of colors that a color device can produce. Different color devices have different color gamuts. A color gamut can also be a range of colors that is theoretically defined, apart from a particular color device. Gamut mapping can preserve color appearance when a color is transferred from one color gamut to another color gamut, such as from a monitor gamut to a printer gamut. Current gamut mapping processes can map colors from a source gamut to a gamut of a destination device. However, in some circumstances, some colors may be undefined with respect to a particular device gamut. In gamut mapping, mapping is commonly described as being from a “source” gamut to a “destination” gamut. However, what is referred to as the “source” gamut may in some instances by the gamut of a device intermediate in the imaging process (such as a scanner or color monitor), and not that of the device on which the image was originally created.

In current gamut mapping processes, color data from an image that do not fit within a source gamut can be clipped to that gamut prior to color processing and mapping to a gamut of a destination device. This can cause color data that are outside the source gamut to be mapped to points inside the destination gamut, thereby not utilizing the full destination gamut and causing inaccurate mapping for colors near the destination gamut boundary. This can result in undesirable color appearance effects for color data that have gamuts and primaries undefined to a particular source gamut.

### BRIEF DESCRIPTION OF THE DRAWINGS

FIG. 1 illustrates an example color processing system suitable to process color data, according to embodiments of the present disclosure.

FIG. 2 illustrates an example gamut comparison of a first device gamut and a second device gamut in three-dimensional color space.

FIG. 3 illustrates another example gamut comparison of a first device gamut and a second device gamut in two-dimensional color space.

FIG. 4A illustrates an example chromaticity graph showing a color gamut and an encoding gamut.

FIG. 4B illustrates a chromaticity graph showing an encoding of a color gamut according to embodiments of the present disclosure.

FIG. 4C illustrates a portion of a chromaticity graph showing an encoding of a color gamut according to embodiments of the present disclosure.

FIG. 5A illustrates an example chromaticity graph showing mapped color data reflecting previous approaches.

FIG. 5B illustrates a chromaticity graph showing mapped color data, according to embodiments of the present disclosure.

FIG. 6A is a flow chart illustrating an embodiment of a method of processing color data, according to embodiments of the present disclosure.

FIG. 6B is a flow chart illustrating various embodiments of moving color data to a color device gamut, according to embodiments of the present disclosure.

### DETAILED DESCRIPTION

Embodiments of the present disclosure include methods, computer readable media, computing devices, and ASICs that include executable program instructions for processing color data undefined to a source gamut. One method embodiment includes receiving color data to a source device, e.g., first device, having a defined color gamut, and preserving color data that are undefined for the source device color gamut. This embodiment also includes mapping color data that are inside the source device color gamut to a destination device, e.g., second device, having a defined color gamut, and mapping color data that are outside the source device color gamut to the destination device color gamut. As used herein, a source device, e.g., first device, and its respective may in some instances be the gamut of a device intermediate in the imaging process.

According to various embodiments of the present disclosure, program instructions that are storable in a memory and executable by software, firmware, hardware, processing modules, or an ASIC can perform color processing on color data that are undefined with respect to a color gamut of a source device (i.e. color data that has an approximated gamut). This approach can preserve colors that are outside the source gamut by not mapping and/or clipping them to the source gamut, but by mapping and/or clipping them to a destination device color gamut.

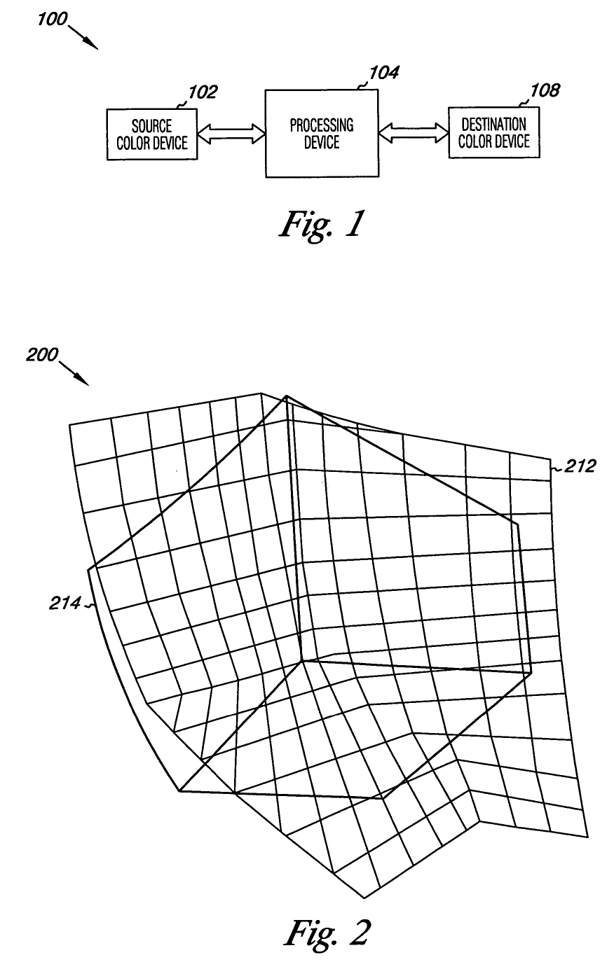

FIG. 1 illustrates an example color processing system suitable to process color data, according to embodiments of the present disclosure. FIG. 1 illustrates a color processing system 100. The color processing system 100 includes a source color device 102, a processing device 104, and a destination color device 108. In one embodiment, the source color device 102 is a color monitor and the destination color device 108 is a digital color printer. In various other embodiments, the source color device 102 can be a camera, a scanner, a monitor, or another color device. In various other embodiments, the destination color device 108 can be a monitor, a printer, or another color device. In some embodiments, the destination color device 108 can be an output device. Various source color devices can be combined with various destination color devices in different combinations, as will be understood by one of ordinary skill in the art.

The processing device 104 can process a color that is transferred from the source color device 102 to the destination color device 108 through use of program instructions that can execute to perform color processing. The source device 102 and the destination device 108 each have a color gamut. In one embodiment, the color gamut of the source device 102 is different from the color gamut of the destination device 108. In this embodiment, in order to preserve color appearance when a color is transferred from one device to another (i.e. from a monitor to a printer) program instructions can execute to analyze the color gamut of each device and to determine the differences. Program instructions can also execute to account for these differences as the processing device 104 performs gamut mapping.

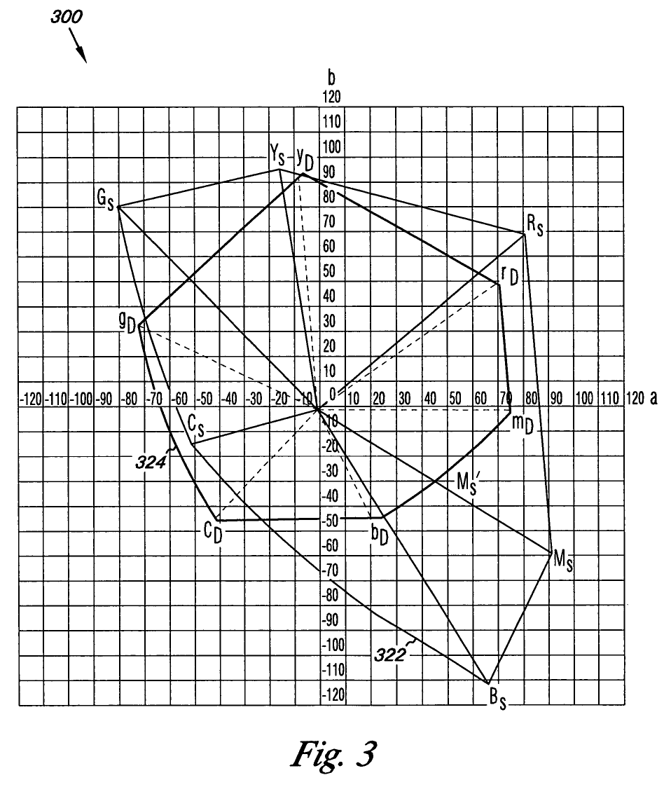

Program instructions can execute to map colors from one color device to another color device by using gamut mapping in a device-independent color exchange space such as CIELAB, CIELUV, CIEXYZ, CIECAM97s JAB, or CIECAM02 JAB. Program instructions can also execute to generate a multiple-dimensional lookup table (LUT) that defines color mapping between gamuts of different color devices. For example, program instructions can execute to generate a three dimensional (3D) RGB to CMY LUT that defines color mapping from a monitor RGB color gamut to a printer CMY color gamut. In another example, program instructions can execute to perform embodiments described herein, which include generating color data to form an International Color Consortium (ICC) profile, as will be understood by one of ordinary skill in the art. The relationship between gamuts of different color devices are described further in FIG. 2.

FIG. 2 illustrates an example gamut comparison of a source gamut and a destination device gamut in three-dimensional color space. FIG. 2 shows a source color gamut 212 and a destination color gamut 214 in a three-dimensional color space 200. In the embodiment of FIG. 2, the source color gamut 212 is associated with a color monitor that is represented in RGB color space and the destination color gamut 214 is associated with a digital color printer that is represented in CMY color space. Program instructions can execute so that the processing device 104 of FIG. 1 performs a method of color processing which transfers color data from the source color gamut 212 to the destination color gamut 214. This method can be used to transfer a color image from the color monitor associated with the source color gamut 212 to the digital color printer associated with the destination color gamut 214.

In one embodiment of color processing, program instructions can execute to perform color appearance modeling, which can include white point adjustment and black point adjustment. In these adjustments, program instructions can execute to map color data to a common white point and a common black point and to process neutral points from a source color gamut to a destination color gamut. In another embodiment of color processing, program instructions can execute to determine a set of aimed primaries before primary mapping. Program instructions can execute to adjust hue, lightness, and chroma for primary mapping and preference adjustment. In one color processing method, six primary colors (i.e. RGBCMY) are used, although more or less may be used in various embodiments.

In the example gamut comparison of FIG. 2, the source color gamut 212 is larger than the destination color gamut 214, although the source color gamut 212 does not encompass the entire destination color gamut 214. In one embodiment, program instructions can execute to generate a three dimensional 3D LUT that defines color mapping from the source color gamut 212 to the destination color gamut 214. For example, program instructions can execute to generate a 17×17×17 3D LUT that defines color mapping from RGB to CMY.

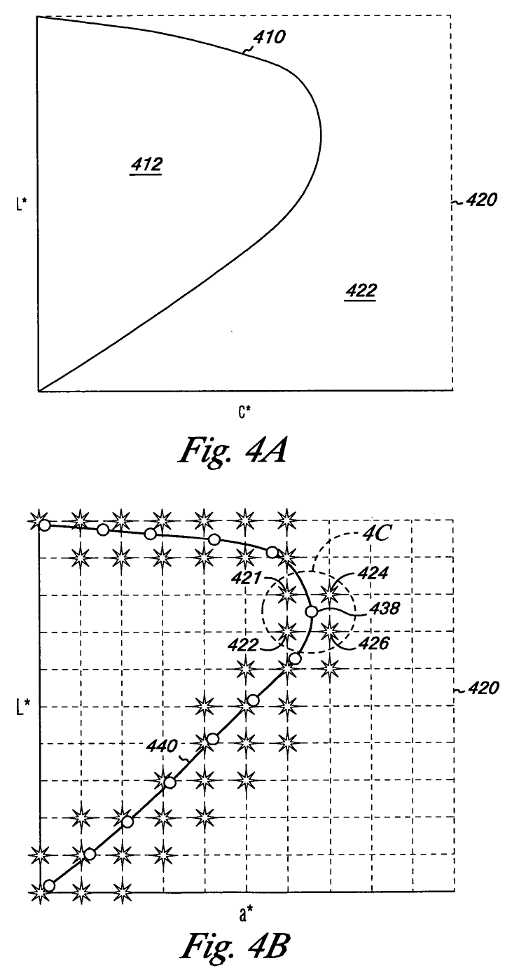

In FIG. 2, the source color gamut 212 and the destination color gamut 214 share some common points of color data, but do not share every point of color data. Some points of color data that are in the source color gamut 212 are not in the destination color gamut 214 (for example, see the lower-right portion of the source color gamut 212). Similarly, some points of color data that are in the destination color gamut 214 are not in the source color gamut 212 (for example, see the lower-left portion of the destination color gamut 214). An illustration with further detail is provided in FIG. 3.

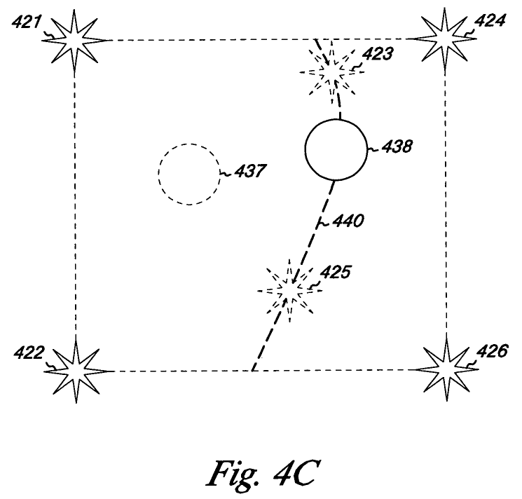

FIG. 3 illustrates another example gamut comparison of a source gamut and a destination device gamut in a two-dimensional color space. FIG. 3 illustrates the gamut comparison of FIG. 2 at a particular lightness value. In the embodiment of FIG. 3, a color exchange space 300 shows a planar slice 322 from the source color gamut 212 of FIG. 2 and a planar slice 324 from the destination color gamut 214 of FIG. 2. The planar slice 322 illustrates primary colors of a source gamut: green (G_{S}), yellow (Y_{S}), red (R_{S}), magenta (M_{S}), blue (B_{S}), and cyan (C_{S}). Similarly, the planar slice 324 from the destination color gamut 214 illustrates primary colors of a destination device gamut: green (G_{D}), yellow (Y_{D}), red (R_{D}), magenta (M_{D}), blue (B_{D}), and cyan (C_{D}). A method of encoding such gamuts is described in FIGS. 4A-4C.

FIG. 4A illustrates an example chromaticity graph showing a color gamut and an encoding gamut. The graph of FIG. 4A shows the gamuts in terms of L* (lightness) and C* (chromaticity). The graph of FIG. 4A includes the color gamut 412, which is bounded by a color gamut boundary 410. The graph of FIG. 4A also includes the encoding gamut 422, which is bounded by an encoding gamut boundary 420. In one embodiment of the present disclosure, program instructions can execute to gamut map colors from the encoding gamut 422 to an output gamut, by using the color gamut 412, without clipping the encoding gamut 422 to the color gamut 412, as described in FIG. 4B.

FIG. 4B illustrates a chromaticity graph showing an encoding of a color gamut according to embodiments of the present disclosure. The graph of FIG. 4B shows the gamuts in terms of L* and a*, in which a* is a portion of C*, as will be understood by one of ordinary skill in the art. (In the graph of FIG. 4B, a b* portion of C* has been left out for simplicity.) FIG. 4B includes an encoding grid 420 and a color gamut boundary 440. The color gamut boundary 440 represents an a* component of the color gamut boundary 410 of FIG. 4A.

The graph of FIG. 4B shows encoding nodes and boundary points. The encoding nodes are represented by stars at certain intersections on the encoding grid 420, such as encoding nodes 421, 422, 424, and 426. Some of the encoding nodes fall inside the color gamut boundary 440 and some of the encoding nodes fall outside the color gamut boundary 440. In one embodiment of the present disclosure, program instructions can execute to encode the color gamut boundary 440 by using the encoding nodes to map the locations of boundary points, as described in FIG. 4C. The boundary points are represented by circles on the color gamut boundary, such as boundary point 438. The locations of the encoding nodes and the boundary points in FIG. 4B are shown for illustrative purposes only and are not intended to limit the scope of the present disclosure to any particular node location or point location.

FIG. 4C illustrates a portion of a chromaticity graph showing an encoding of a color gamut according to embodiments of the present disclosure. The portion illustrated in FIG. 4C corresponds with the portion labeled 4C in FIG. 4B. As in FIG. 4B, FIG. 4C includes the encoding nodes 421, 422, 424, and 426, the boundary point 438, and the color gamut boundary 440. Program instructions can execute to use the encoding nodes 421, 422, 424, and 426 to map points that represent color data by using interpolation and to clip mapped points to the color gamut boundary as will be understood by one of ordinary skill in the art.

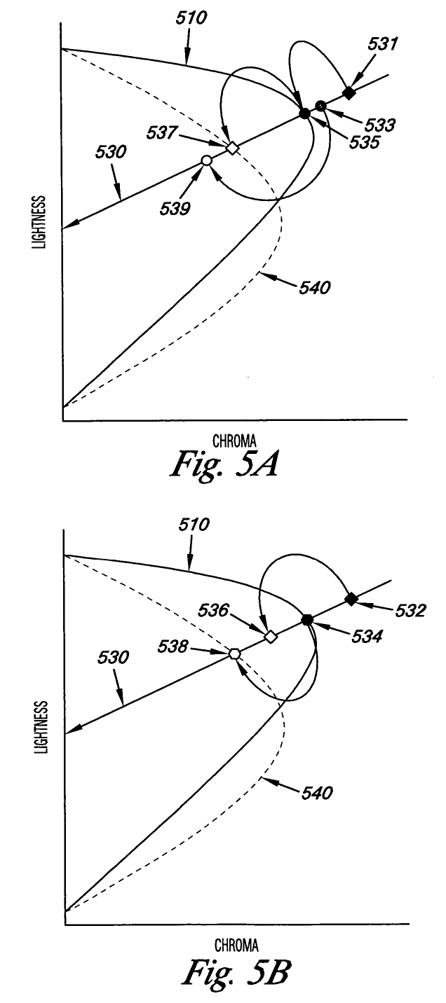

Since each of the encoding nodes 421, 422, 424, and 426 are located at regular intervals, and are not clipped to the color gamut boundary 440, program instructions can execute to map and clip points that represent color data outside the color gamut boundary 440. In the embodiment of FIG. 4C, a point that represents color data outside the color gamut boundary 440 is mapped by using the encoding nodes 421, 422, 424, and 426 and then clipped to the color boundary 440 to form the boundary point 438. Since the boundary point 438 falls on the color gamut boundary 440, the point represents color data that utilizes the full color gamut associated with the color gamut boundary 440. Additionally, since the encoding nodes 421, 422, 424, and 426 are not clipped to the color gamut boundary 440, program instructions can execute to accurately map color data points near the color gamut boundary 440, as will be understood by one of ordinary skill in the art. The use of encoding nodes that are not clipped to a color gamut boundary is described further in FIG. 5B.

The embodiment of FIG. 4C also illustrates an effect of an embodiment that clips encoding nodes to a color gamut and uses those clipped encoding nodes to map color data. In an embodiment that clips encoding nodes, encoding nodes that are outside the color gamut 440 are clipped to the color gamut 440. In this embodiment, the encoding nodes 421 and 422 are not clipped, since they are not outside the color gamut 440. However, in this embodiment, the encoding nodes 424 and 426 are clipped, since they are outside the color gamut boundary 440. The clipped encoding node 423 represents an embodiment of the encoding node 424 that is clipped to the color gamut boundary 440. The clipped encoding node 425 represents an embodiment of the encoding node 426 that is clipped to the color gamut boundary 440. Program instructions can execute to use the clipped encoding nodes 423 and 425 to map points that represent color data by using interpolation.

In an embodiment that uses clipped encoding nodes to map color data, since clipped encoding nodes 423 and 425 are clipped to the color gamut boundary 440, points that represent color data outside the color gamut boundary 440 are mapped to locations inside the color gamut 440. In this embodiment, a point that represents color data outside the color gamut boundary 440 is mapped by using the encoding nodes 421 and 422 and the clipped encoding nodes 423 and 425 to form the interpolated point 437, which is inside the color gamut boundary 440. Since the interpolated point 437 falls inside the color gamut boundary 440, the point represents color data that does not utilize the full color gamut of a color associated with the color gamut boundary 440. Additionally, since the clipped encoding nodes 423 and 425 are clipped to the color gamut boundary 440, color data points near the color gamut boundary 440 will not be accurately mapped, as will be understood by one of ordinary skill in the art. Embodiments that clip encoding nodes to a color gamut and/or use clipped encoding nodes to map color data are presented herein solely to illustrate their effects, and are not intended to limit embodiments of the present disclosure. Specific examples of mapping color data are described in FIGS. 5A-5B.

FIG. 5A illustrates an example chromaticity graph showing mapped color data reflecting previous approaches. FIG. 5A illustrates gamut mapping at a particular hue angle. The particular hue angle can be different in different embodiments. FIG. 5A includes a source gamut boundary 510, a chroma scaling line 530, and a destination device gamut boundary 540. The graph of FIG. 5A shows points that represent color data, including a first out-of-gamut point 531, a second out-of-gamut point 533, a clipped point 535, a first mapped point 537, and a second mapped point 539. The first out-of-gamut point 531 and the second out-of-gamut point 533 are outside the source gamut boundary 510, so they are undefined with respect to a source gamut associated with the source gamut boundary 510. The second out-of-gamut point 533 has less chroma than the first out-of-gamut point 531. The clipped point 535 is on the source gamut boundary 510. The first mapped point 537 is on the destination device gamut boundary 540. The second mapped point 539 is inside the destination device gamut boundary 540.

In previous approaches, program instructions can execute to transfer color data associated with the source gamut boundary 510 to a destination device associated with the gamut boundary 540. In one previous approach, program instructions can execute to clip the first out-of-gamut point 531 to the source gamut boundary 510 to form the clipped point 535 and gamut map the clipped point 533 to the destination device gamut boundary 540 to form the first mapped point 537. In another previous approach, program instructions can execute to map the second out-of-gamut point 533, by performing an interpolation that uses some encoding nodes inside the source gamut boundary 510 and some clipped encoding nodes on the source gamut boundary 510, resulting in the second mapped point 539 being inside the destination device gamut boundary 540, for reasons illustrated in FIGS. 4B and 4C, as will be understood by one of ordinary skill in the art. Since the second mapped point 539 is inside the destination device gamut boundary 540, the second mapped point 539 represents color data that does not utilize the full color gamut of a destination device associated with the destination device gamut boundary 540.

FIG. 5B illustrates a chromaticity graph showing mapped color data, according to embodiments of the present disclosure. FIG. 5B illustrates gamut mapping at the hue angle of FIG. 5A, however, as in FIG. 5A, the particular hue angle can be different in different embodiments. FIG. 5B has elements of FIG. 5A, including the source gamut boundary 510, the chroma scaling line 530, and the destination device gamut boundary 540. The graph of FIG. 5B also shows points that represent color data, including an out-of-gamut point 532, a point 534 on the source gamut boundary, a first mapped point 536, and a second mapped point 538. The out-of-gamut point 532 is outside the source gamut boundary 510, so the out-of-gamut point 532 is undefined with respect to the source gamut boundary 510. The out-of-gamut point 532 is also a node of a LUT. The point 534 is on the source gamut boundary 510 and is not a node of the LUT. The mapped point 536 is outside the destination device gamut boundary 540. The second mapped point 538 is on the destination device gamut boundary 540.

In embodiments of the present disclosure, program instructions can execute to transform color data that is received to the source gamut associated with the source gamut boundary 510 to a destination device associated with the gamut boundary 540. These embodiments of the present disclosure do not clip the out-of-gamut point 532 to the source gamut boundary 510. Instead, according to these embodiments, program instructions can execute to preserve color data that is undefined with respect to the source gamut boundary 510. In one embodiment, this preserved color data can be color processed. In still another embodiment, this preserved color data can be transformed to a destination device associated with the gamut boundary 540. This transformation can be accomplished with gamut mapping, which can include using chroma-scaling factors to map a point to extrapolated locations along a chroma scaling line, such as the chroma scaling line 530.

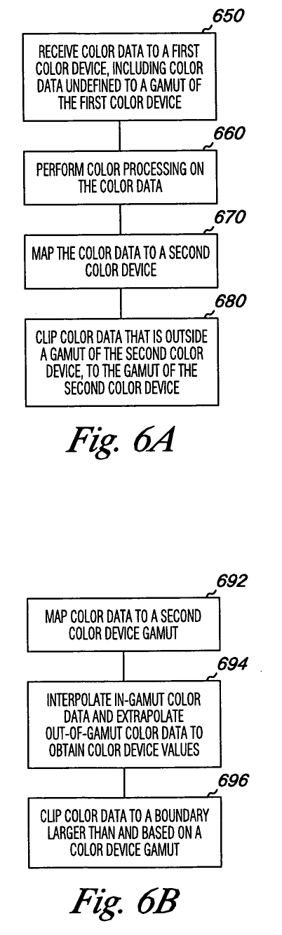

In the embodiment of FIG. 5B, program instructions can execute to perform gamut mapping. Program instructions can execute to gamut map the out-of-gamut point 532 to the first mapped point 536. In one embodiment, program instruction can execute so that out-of-gamut color data for mapped nodes of a LUT, such as the first mapped point 536, can be encoded for interpolating other source colors, as will be understood by one of ordinary skill in the art. In a variation of this encoding embodiment, program instructions can also execute to use a post one dimensional (1D) LUT to clip interpolated source colors that are outside the destination device gamut boundary 540 to the destination device gamut boundary 540. Program instructions can also execute to gamut map the point 534 to the destination device gamut boundary 540 by interpolation to form the mapped point 538. Since points on the source gamut boundary 510 are interpolated to the destination device gamut boundary 540, the destination device gamut associated with the destination device gamut boundary 540 is fully utilized. This mapping of points that represent color data that are outside a source gamut to a destination device is further described in FIGS. 6A and 6B.

Various embodiments of the present disclosure can include variations of the embodiments of FIG. 5B. According to one variation, program instructions can also execute to map color data that are inside a source gamut to a destination device. In another variation, program instructions can execute to process color data to prepare a representation of a color image to be produced by a destination device. According to another variation, program instructions can execute to generate a look-up-table that defines color mapping from a source to a destination device, according to the embodiments described in FIG. 5B. In still another variation, program instructions can execute to clip mapped points to a boundary that is larger than the color gamut of a destination device and based upon the color gamut of the destination device, as will be understood by one of ordinary skill in the art.

FIGS. 6A and 6B illustrate method embodiments according to the present disclosure. The method embodiments described herein can be performed by software and/or firmware (i.e., computer executable instructions), hardware, application modules, and the like, executable and/or resident on the systems and devices shown herein or otherwise. Embodiments of the invention are not limited to any particular operating environment or to instructions written in a particular programming language. Software, firmware, and/or processing modules, suitable for carrying out embodiments of the present invention, can be resident in one or more devices or locations. Processing modules can include separate modules connected together or include several modules on an ASIC.

Unless explicitly stated, the method embodiments described herein are not constrained to a particular order or sequence. Additionally, some of the described method embodiments or elements thereof can occur, or be performed at, the same point in time.

FIG. 6A is a flow chart illustrating an embodiment of a method of transferring received color data, according to embodiments of the present disclosure. At Block 650, program instructions can execute to receive color data to a first color device having a defined gamut, the color data including color data undefined to a gamut of the first color device. In various embodiments, the first color device can be referred to as a source device, as described in FIG. 1, but may actually be a device intermediate in the imaging process. Program instructions for Block 660 can execute to perform color processing on the color data, which can include color appearance modeling, one or more primary adjustments, and/or other types of color processing. At Block 670, program instructions can execute to map the color data to a second color device, which can include a destination device. This mapping can include color data that are inside a gamut of the second color device, or color data that are outside the gamut of the second color device, or both. Program instructions corresponding to Block 680 can execute to clip color data that is outside the gamut of the second color device, to the gamut of the second color device, by using clipping methods that are known to one of ordinary skill in the art. In the chart of FIG. 6A, Blocks 670 and 680 represent transferring color data to a destination, which can also be accomplished as described in FIG. 6B.

FIG. 6B is a flow chart illustrating various embodiments of transferring color data to a destination, according to embodiments of the present disclosure. At Block 692, program instructions can execute to map color data to a second color device gamut. In the embodiment of Block 692, some mapped color data may be outside the second color device gamut, since the color data to be mapped may be outside a source gamut, as described herein. Program instructions corresponding to Block 694 can execute to interpolate in-gamut color data to a destination device color space and extrapolate out-of-gamut color data to obtain color values in the device color space. In the embodiment of Block 694, some extrapolated color data may be outside the destination device color space. At Block 696, program instructions can clip color data to a boundary larger than the device color gamut. The embodiment of Block 696 can be accomplished by allowing color values in the color space of the color device to be outside the color device's physical range, as will be understood by one of ordinary skill in the art.

Although specific embodiments have been illustrated and described herein, those of ordinary skill in the art will appreciate that an arrangement calculated to implement the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the programs and methods disclosed above are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for color processing color data, comprising:
receiving color data to a first device having a defined color gamut;
preserving color data that are undefined for the first device color gamut;
mapping color data that are inside the first device color gamut to a second device color gamut; and
mapping color data that are outside the first device color gamut to the second device color gamut.

2. The method of claim 1, wherein receiving the color data includes receiving photographic color data and computer edited color data.

3. The method of claim 1, wherein:
receiving the color data includes receiving the color data to a first device color gamut that has three-dimensions, including RGB color space; and
mapping the color data that are inside includes mapping the color data that are inside the first device color gamut to a second device color gamut that has at least four dimensions, including CMYK color space.

4. The method of claim 1, including performing the method in the sequence presented.

5. A method for color processing color data, comprising:
receiving color data to a first device color gamut;
color processing the color data to preserve colors that are outside the first device color gamut; and
mapping the color data, including colors that are outside the first device color gamut, to a second device color gamut.

6. The method of claim 5, wherein the mapping includes mapping the color data, including colors that are outside the color gamut of the first device, to a boundary that is:
based upon a second device color gamut; and
larger than the second device color gamut.

7. A method for processing color, comprising:
providing a first device with a first gamut;
providing a color image that has an approximated color gamut and an approximated primary set; and
receiving color data that represent a color of the color image that is outside the first gamut, by using the first device.

8. The method of claim 7, wherein:
receiving the color data includes receiving color data selected from the group including: a digital camera input, photographic color data, a monitor output, and computer edited color data; and
providing the first device includes providing a first device selected from the group including: a camera, a scanner, a monitor, and a non-physical color device.

9. A computer readable medium, having instructions stored thereon for causing a device to perform a method, comprising:
receiving color data that represent colors from an image, including color data that represent colors outside a gamut of a first device;
converting the color data to color exchange space values, without clipping colors from the image that are outside the gamut of the first device to the gamut of the first device; and
processing the color exchange space values to prepare a representation of the image to be produced by a second device.

10. The computer readable medium of claim 9, wherein the receiving includes receiving color data that represent colors from an image, including color data that represent an approximate primary color with a gamut that is undefined to the first device.

11. The computer readable medium of claim 10, wherein the processing includes performing color appearance modeling on color exchange space values that represent the approximate primary color.

12. The computer readable medium of claim 10, wherein the processing includes performing primary adjustment on color exchange space values that represent the approximate primary color.

13. The computer readable medium of claim 9, including:
mapping the color exchange space values to the second device; and
clipping color exchange space values that are outside a gamut of the second device to the gamut of the second gamut.

14. The computer readable medium of claim 13, wherein the converting includes generating an ICC profile.

15. The computer readable medium of claim 13, wherein the mapping includes mapping the color exchange space values that are outside a gamut of the second device to extrapolated locations of the gamut of the second gamut by using a chroma-scaling factor.

16. A computing device, comprising:
a processor;
a memory coupled to the processor;
program instructions storable in the memory and executable by the processor to receive color data to a first device, without clipping colors that are outside a first gamut to the first gamut.

17. The device of claim 16, including program instructions storable in the memory and executable by the processor to generate a look-up-table for mapping the color data to a second gamut of an output device.

18. The device of claim 17, including program instructions storable in the memory and executable by the processor to map image data to the second gamut of the output device by using the look-up-table.

19. The device of claim 18, including program instructions storable in the memory and executable by the processor to clip colors that are outside the second gamut to the second gamut.

20. The device of claim 18, including program instructions storable in the memory and executable by the processor to map colors that are outside the first gamut to the second gamut by using the look-up-table.

21. A device, comprising:
a processor;
a memory coupled to the processor;
means for processing color data that represent colors of an image received by a first device, including color data that represent a color outside a first gamut of the first device, without clipping colors that are outside the first gamut to the first gamut.

22. The device of claim 21, including means for preserving color data from the image that is undefined to the first gamut during a color transfer between the first device and a second device.

23. The device of claim 21, including means for mapping at least a portion of the color data, including color data that represent the color outside the gamut of the first device, to a gamut of the second device.
